(19) United States
(12) Patent Application Publication
(10) Pub. No.: US 2024/0037459 A1
(43) Pub. Date: Feb. 1, 2024

(54) DATABASE OPERATIONS AND ANALYSIS FOR VIRTUAL INTERLINING OF TRAVEL ROUTES

(71) Applicant: Hopper, Inc., Montreal (CA)

(72) Inventors: Mahmoud Pourmehrab, Gainesville, FL (US); David G. D'Alessandro, Atlanta, GA (US)

(21) Appl. No.: 17/878,745

(22) Filed: Aug. 1, 2022

(51) Int. Cl. G06Q 10/02; G06F 16/29; G01C 21/34

(52) U.S. Cl. CPC G06Q 10/02; G06F 16/29; G01C 21/343

(57) ABSTRACT

A system and a method for generating and displaying candidate itineraries for travel. In an embodiment, the system receives, from an application installed on a client device, a request to book travel between an origin location and a destination location. The request includes multiple parameters. Responsive to receiving the request, the system applies a subset of the parameters to a constrained function, and ranks the routes between the origin location and the destination location by applying the constrained function to a route graph. The system then determines a subset of the routes based on the ranking, and requests from external data providers travel route data on the subset of routes. The system then determines candidate itineraries between the origin location and the destination location, and generates for display on the client device the candidate itineraries.

### TECHNICAL FIELD

The disclosure generally relates to the field of database operations, and more particularly relates to database generation and analysis for the purpose of virtual interlining of database information from disparate sources.

### BACKGROUND

Travel using common carriers, such as air travel, is often planned using a single carrier. However, by combining travel across non-contiguous segments, travel may be better optimized for a given traveler's needs (e.g., resulting in reduced layover times, short trips that take less time or less fuel, and other efficiencies). Algorithmically, given parameters for a trip such as an origin, a destination, a trip type, trip dates, and so on, it is computationally impractical, and perhaps impossible using today's available computational capacity, to compute every possible route by combining every possible leg offered by every possible carrier in order to determine best combinations across non-contiguous segments for a traveler to take.

### SUMMARY

Systems and methods are disclosed herein for computing travel routes involving two or more non-contiguous segments. Two segments of a trip are non-contiguous when the two segments are ticketed separately, which may be ticketed by a same carrier, or two different carriers. The non-contiguous segments of a trip are difficult to assemble, often because two carriers (that facilitate the two segments of travel) do not have an agreement to facilitate certain aspects of travel, such as (but not limited to) booking, cancelation, refund, misconnection, and baggage handling through one airline, even though the segments are operated by different carriers. Theoretically, users could go to different carriers' systems to search for flights they offer, and assemble travel involving two or more non-contiguous segments that fits their needs. However, there are thousands of carriers that offer tens of millions of flight options or segments per day, and each flight is associated with many parameters. Considering all the flights and all the associated parameters is such a daunting task, that even the most advanced modern computer systems cannot provide an answer within a reasonable time range. Additionally, different users have different preferences and needs. Identifying itineraries among the millions of segments that fit a particular user's need is even more difficult. The principles described herein solve the above-described problem by generating a route graph based on historical data, obtaining a subset of routes in the route graph based on applying a subset of parameters to a constrained function, and applying the constrained function to a route graph to identify a subset of routes in the route graph, and then searching carrier systems for the subset of routes to then identify a set of itineraries that are currently offered by carriers and fit a user's need.

One embodiment of a disclosed system, method, and computer-readable storage medium includes generating a route graph using historical information, the route graph having nodes at each hop location, and edges between hops. The edges may show additional information, such as trip type, distance, time, and so on. The historical information is obtained from prior usage of the application installed on various client devices and stored on one or more databases of the electronic travel service.

The system also receives, from an application installed on a client device, a request to book travel between an origin location and a destination location. The request includes a plurality of parameters. The system applies a subset of the plurality of parameters to a constrained function responsive to receiving the request. The system then ranks routes between the origin location and the destination location by applying the constrained function to the route graph. The route generation module then determines a subset of the routes based on the ranking.

The system then requests, from one or more external data providers, travel route data on the subset of routes that satisfy each of the plurality of parameters, and determines, from the travel route data, candidate itineraries between the origin location and the destination location that satisfy each of the plurality of parameters. At least one of the candidate itineraries includes at least one component from each of at least two non-contiguous segments that are ticketed separately by one or more carriers. The system then generates for display on the client device the candidate itineraries.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of an environment for interfacing a client device with an electronic travel service.

FIG. 2 illustrates one embodiment of exemplary modules and databases of the electronic travel service.

FIG. 3 illustrates one embodiment of exemplary modules of a graph generation module of the electronic travel service.

FIG. 4 illustrates an exemplary route graph generated by the graph generation module of the electronic travel service.

FIG. 5 illustrates one embodiment of an exemplary route generation module of the electronic travel service.

FIG. 6 illustrates one embodiment of an exemplary process that may be performed by a segment selection module of the electronic travel service.

FIG. 7A illustrates an embodiment of exemplary UI generated by a UI generation module of the electronic travel service for displaying one or more candidate itineraries from city A to city D.

FIG. 7B illustrates an embodiment of exemplary UI updated by the UI generation module of the electronic travel service for displaying updated one or more candidate itineraries from city A to city D, responsive to a user's interaction with a previously displayed UI shown in FIG. 7A.

FIG. 8 is a block diagram illustrating components of an example machine able to read instructions from a machine-readable medium and execute them in a processor (or controller).

FIG. 9 illustrates one embodiment of an exemplary flow chart for generating and displaying candidate itineraries for travel at an application installed on a client device.

### DETAILED DESCRIPTION

Interlining, also known as interline ticketing and interline booking, is a voluntary commercial agreement between individual airlines to handle passengers traveling on itineraries that require multiple flights on multiple airlines. Travel using common carriers, such as air travel, is often planned using a single carrier or carriers having such voluntary commercial agreements. However, by combining travel across non-contiguous segments (which are segments that are separately ticketed without interlining), travel may be better optimized for a given traveler's needs (e.g., resulting in reduced layover times, short trips that take less time or less fuel, and other efficiencies).

Virtual interlining is a service provided to users by suggesting routes including non-contiguous segments. However, algorithmically, given parameters for a trip such as an origin, a destination, a trip type, trip dates, and so on, it is computationally impractical, and perhaps impossible using today's available computational capacity, to compute every possible route by combining every possible leg offered by every possible carrier in order to determine best combinations across non-contiguous segments for a traveler to take. The principles described herein solve the above-described problem by generating a route graph based on historical data, obtaining a subset of routes in the route graph based on applying a subset of parameters to a constrained function, and applying the constrained function to a route graph to identify a subset of routes in the route graph, and then searching carrier systems for the subset of routes to then identify a set of itineraries that are currently offered by carriers and fit a user's need.

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Electronic Travel Service

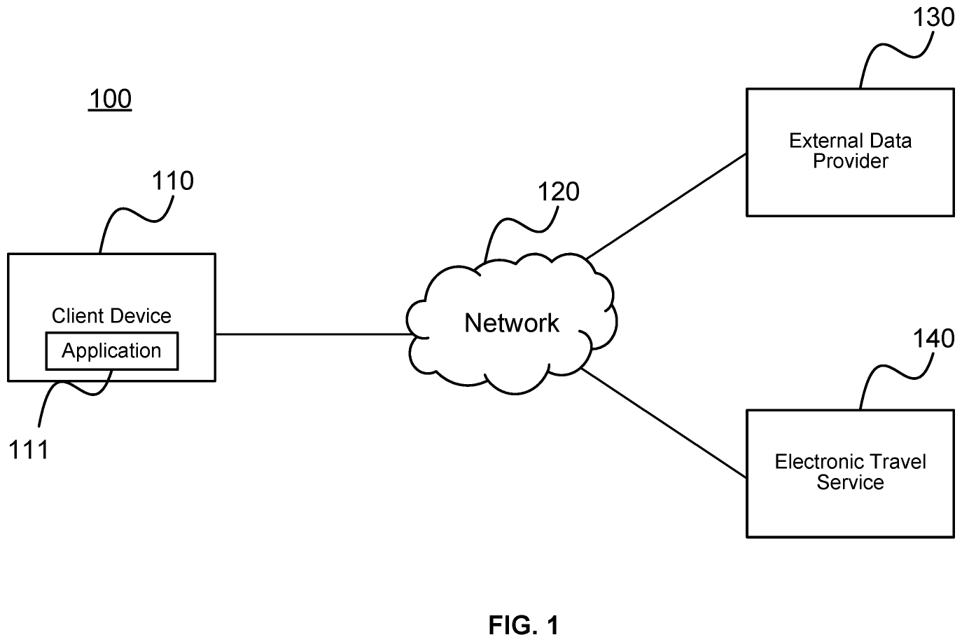

FIG. 1 illustrates one embodiment of an environment for interfacing a client device with an electronic travel service. FIG. 1 includes client device 110, network 120, external data provider 130, and electronic travel service 140. Client device 110 may be any device facing an end user. Examples of client devices include mobile devices like smart phones and tablet computers, laptops, personal computers, smartwatches, internet-of-things (IoT) devices, and any other device with, or capable of being coupled to, a display with which the user can interact to cause data to be transmitted over a network. Network 120 may be any data network, such as the Internet or any other network that facilitates data communication between client device 110 and a service.

Client device 110 includes application 111. Application 111 may be downloaded from electronic travel service 140. In some embodiments, application 111 may be a web application configured to be accessed via a browser, a browser extension, a browser add-on, or a downloadable application that is downloaded onto the client device 110. In any case, application 111 enables a user of client device 110 to request to book travel. For example, a user using the client device 110 may input a request including an origin location and a destination location. A plurality of parameters are explicitly or implicitly associated with the request. In some embodiments, the user may input some parameters. In some embodiments, because each route between the origin location and the destination location is associated with a plurality of parameters, the request is implicitly associated with the plurality of parameters. In some embodiments, the plurality of parameters include one or more of indicia of directionality of route, a maximum number of layovers, acceptable carriers, duration constraints, and/or layover time constraints. Note, the principles described herein are not limited to air travel, and they can be applied to other transportation means, such as (but not limited to) trains and buses, and other travel-related bookings, such as (but not limited to) hotel bookings and rental car bookings.

The origin location and the destination location transmitted over network 120 (which may be any data communications network, such as the Internet) to electronic travel service 140. Responsive to receiving the request from the client device 110, electronic travel service 140 may apply a subset of the plurality of parameters to a constrained function, which in turn may be applied to a route graph to rank routes between the origin location and the destination location. Electronic travel service 140 may then use the rankings of the routes to determine a subset of the routes.

Notably, it is advantageous to apply a subset of the plurality of parameters that omits one or more of the plurality of parameters to the constrained function because path enumeration of a large well-connected graph is combinatorial explosive. The more parameters are being considered, the more dimensions of computational complexity are to be solved by the electronic travel service 140. The mathematical problem to solve for the bundling strategy is a real challenge due to the voluminous combinations of paths. Even the most advanced modern computers are incapable of solving such a bundling strategy within a reasonable time for a user. For example, to traverse all the possibilities and consider all the parameters, a computer system may take hours or days to generate a subset of routes. Further, the subset of routes may also include a significant number of segments, which are then queried from the external data provider 130. Notably, each external data provider has its own limited bandwidth. A large number of queries in a short period may take up the bandwidth of the external data provider 130, resulting in a deteriorated performance of the external data provider 130. The electronic travel service 140 described herein solves this problem in part by selecting a subset of the plurality of parameters and applying only the subset of the plurality of parameters to the constrained function, which reduces computation time and usage of resources.

For example, based on a user request, for each possible route, a plurality of parameters should be considered. For example, the plurality of parameters may include a number of layovers, carriers, layover time, availability of free carry-on luggage, total cost, departure time, arrival time, etc. Considering all the plurality of parameters would require performance of massive computations, which may require lots of computing resources and/or take a longer time than a user would like to wait for. In embodiments, to reduce the computation time, a subset of parameters is applied to a constrained function to narrow the search criteria. For example, the subset of parameters may only include a number of layovers, carriers, and layover time. In some embodiments, the subset of the parameters may be a default set of parameters set by the travel service system 140. In some embodiments, the subset of the parameters may be selected based on the user profile and/or user's historical information. For example, travel service system 140 may prioritize a subset of parameters based on the user's historical travel bookings.

The constrained function is then applied to the route graph to rank and select a subset of routes. For example, the constrained function may limit a maximum number of layovers (e.g., 1 stop), acceptable carriers (e.g., carriers A and B), and a maximum layover time (e.g., 2 hours) to identify a subset of routes in the route graph and rank the subset of routes based on their values of the subset of the parameters. In this example, applying the constrained function, the electronic travel service 140 may start from the origin location (or the destination location) on the route graph, and traverse each hub location that is also linked to the destination location to identify the routes that only have 1 stop and offered by carriers A and B. The layover times can then be identified for each of these routes, and the routes that have longer layover times are filtered out. These routes are between the origin location and the destination location and satisfy the constrained function. However, the number of these routes may still be fairly large. These routes may then be ranked based on the value of the subset of parameters to identify a few top-ranked routes. For instance, the routes with the lowest layover time may be ranked the highest, and a few routes with the lowest layover time may be selected to generate a subset of routes. The selection may be based on a predetermined threshold, for example, only the routes with layover time fewer than 2 hours are selected. Alternatively, or in addition, the selection may be based on a predetermined number of the subset of routes that are to be selected, for example, only the top 5 routes are selected.

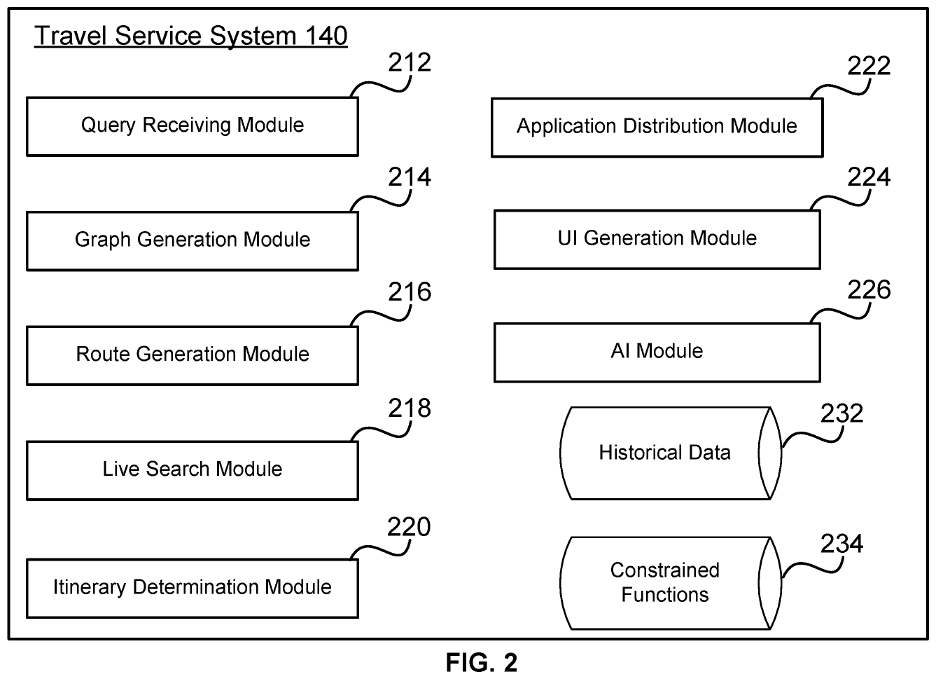

After that, electronic travel service system 140 may then send a request to the external data provider 130 for travel route data on the subset of routes that satisfy each of the plurality of parameters. Responsive to receiving the travel route data, the electronic travel service 140 then determines one or more candidate itineraries between the origin location and the destination location that satisfy each of the plurality of parameters. In some embodiments, a route subgraph is generated based on the travel route data. The routes between the origin location and the destination location in the route subgraph are also ranked, and the determination of the candidate itineraries is based on the ranking of the routes in the route subgraph. Further, at least one of the candidate itineraries includes at least one component from each of at least two non-contiguous segments. Responsive to determining the one or more candidate itineraries, electronic travel service 140 then generates a user interface for display on the client device 110, where the user interface shows the candidate itineraries. Further details about electronic travel service 140 will be described below with respect to FIGS. 2-9.

FIG. 2 illustrates one embodiment of exemplary modules and databases of the electronic travel service. As depicted in FIG. 2, electronic travel service 140 includes query receiving module 212, graph generation module 214, route generation module 216, live search module 218, itinerary determination module 220, application distribution module 222, UI generation module 224, an AI module 226, as well as historical data 232 and constrained function 234. The modules and databases depicted in FIG. 2 are merely exemplary; fewer or more modules may be used to achieve the functionality described herein. Moreover, the modules and databases need not be in a single location, and may be distributed across environment 100 and intercommunicated using network 120.

Historical data 232 is a database accessible to the electronic travel service 140. In some embodiments, the electronic travel service obtains historical data 232 from prior usage of the application (e.g., application 111) installed on various client devices (e.g., client device 110). For example, when a user requests to book travel via application 111, electronic travel service 140 receives the request, determines candidate itineraries, and displays the candidate itineraries on the client device 110, using application 111. After that, the user may then select one of the candidate itineraries to book the travel via application 111. Responsive to the user's selection of the candidate itinerary, electronic travel service 140 receives the user's selection, and generates a query to external data provider 130 to book the travel. Electronic travel service 140 can then store user's request, the candidate itineraries, and/or the user-selected itinerary in historical data 232.

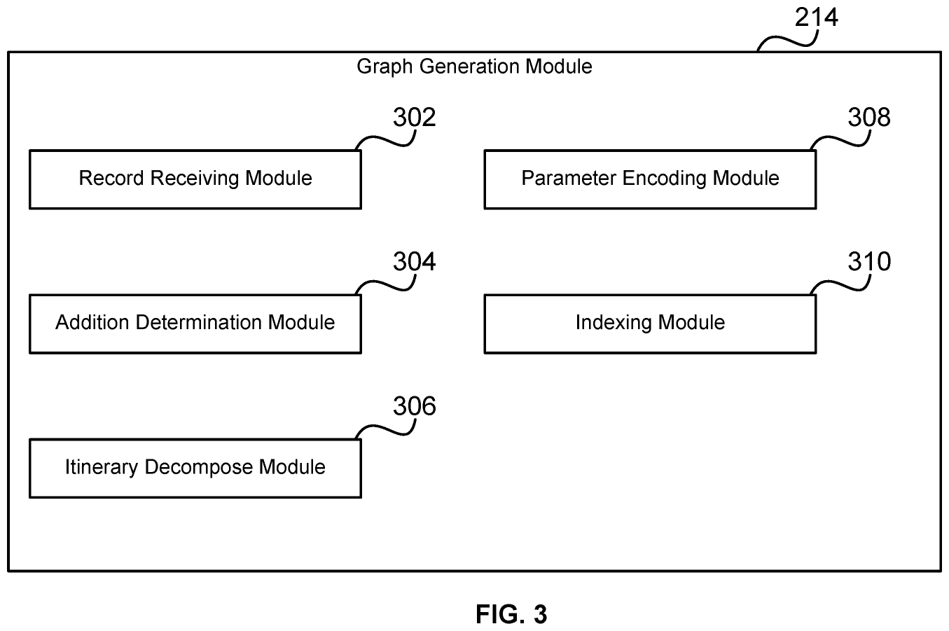

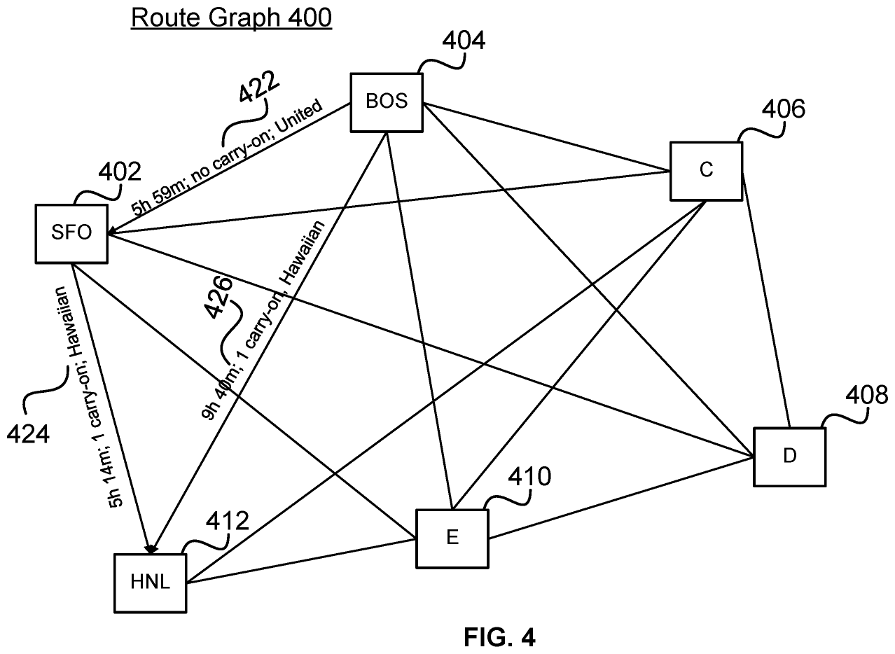

Graph generation module 214 uses historical data 232 to generate a route graph. The route graph includes nodes representing travel hub locations, and edges connecting nodes. In particular, the edges include information indicative of parameters of the historical trips. The parameters may include (but are not limited to) indicia of directionality of route, maximum number of layovers, acceptable carriers, duration constraints, and/or layover time constraints. In some embodiments, the historical parameters may also include departure time, arrival time, a likelihood of delay, distance traveled, time traveled, a capacity of transportation mean, and/or a cost of a trip. Notably, “booking travel” described herein is a database operation that, when effected, causes electronic travel service 140 to access the route graph generated based on historical data, and causes the electronic travel service 140 to store data associated with the booking in historical data 232. The updated historical data 232 may then trigger the route graph to be modified. Further details about graph generation module 214 and the route graph will be described below with respect to FIGS. 3-4.

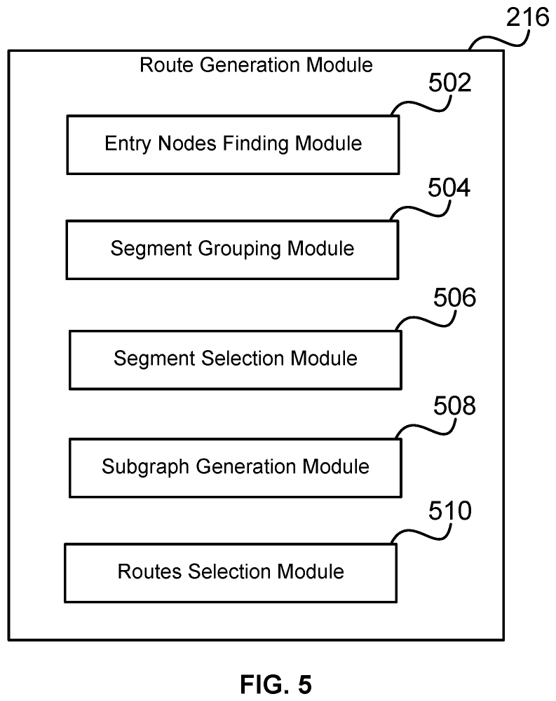

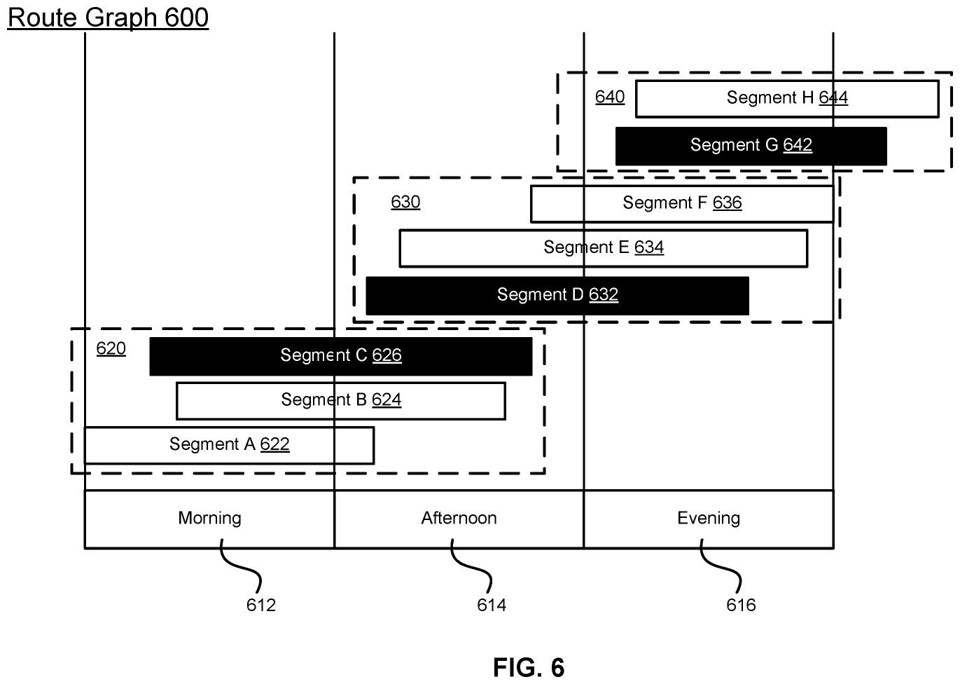

Query receiving module 212 receives requests for travel from one or more client devices (e.g., client device 110). Each request includes an origin location and a destination location, and a plurality of parameters. In some cases, the travel is a round trip travel, the query receiving module 212 separates the travel into two trips, namely (1) an outbound trip from a first location to a second location, and (2) a return trip from the second location to the first location. Responsive to receiving a request, for each trip (e.g., an outbound trip and/or a return trip), query receiving module 212 causes route generation module 216 to apply a subset of parameters to a constrained function 234 and apply constrained function 234 to the route graph to rank routes in the graph, and select a subset of the routes based on the ranking. In some embodiments, determining the subset of routes includes selecting a subset of routes having highest rankings. In some embodiments, the subset of routes is routes that are above a predetermined threshold. Alternatively, or in addition, the subset of routes is a predetermined number of routes. In some embodiments, when no routes are found, route generation module 216 may remove some of the constrains on some of the parameters. Further details about route generation module 216 will be described below with respect to FIGS. 5-6.

After the subset of the routes are determined, the travel service system 140 then sends them to live search module 218 to generate and send one or more queries to one or more external data providers (e.g., external data provider 130). The one or more queries are configured to request real-time travel route data for the subset of routes from the one or more external data providers. The real-time travel route data includes real-time parameters of the subset of the routes, which can be booked by travelers at a current time. Such real-time parameters may include (but are not limited to) indicia of directionality of route, a maximum number of layovers, acceptable carriers, duration constraints, layover time constraints, departure time, arrival time, distance traveled, time traveled, a capacity of transportation mean, and/or a cost of a route that can be booked by a user at a current time.

The real-time travel route data is then processed by itinerary determination module 220 to determine one or more candidate itineraries. In some embodiments, itinerary determination module 220 causes graph generation module 214 to generate a route subgraph based on real-time travel route data received from the external data providers. Itinerary determination module 220 determines the one or more candidate routes based on applying the constraint functions and a subset of parameters to the route subgraph. For example, in some embodiments, itinerary determination module 220 compares values of all the plurality of parameters (or weighted average of the plurality of parameters) of the real-time travel route data associated with the subset of routes, and ranks them based on the values. Because routes (such as airline routes) can change at any time due to various reasons, such as (but not limited to) supply-demand balance, staff availability, etc., a same request from a client device 110 at different times may result in different candidate itineraries. The one or more candidate itineraries may also be ranked similarly to ranking the subset of the routes determined based on historical data 232, although unlike the subset of the routes determined based on historical data 232, the one or more candidate itineraries are determined based on real-time data obtained from external data providers (e.g., external data provider 130).

Because the search results are coming from one or more external data providers, it may take a long time for every external data provider to return the search results back to live search module 218. In some embodiments, the live search module 218 sets a predetermined time threshold, e.g., 10 seconds, 15 seconds. When the predetermined time threshold is reached, live search module 218 cancels or discards the requests sent to the external data providers that have not returned any results, and provides whatever results that have been received to itinerary determination module 220 for further processing. In some embodiments, the live search module 218 also causes the UI generation module 224 to real-time stream the received search results, showing the user the search progress in real time.

Responsive to determining the one or more candidate itineraries, UI generation module 224 then generates a UI at the client device (e.g., client device 110) via application 111 to display the one or more candidate itineraries. As briefly discussed above, the one or more candidate itineraries may be ranked based on a subset of parameters and/or the constraint functions 234. In some embodiments, the UI generation module 224 causes a higher ranked candidate itinerary to be displayed at a higher or a more prominent position.

In some embodiments, a user of the client device can interact with the UI to select one of the one or more candidate itineraries to review additional details, and/or book the itinerary via the external data providers. Because the itinerary may include multiple segments from non-contiguous segments, the non-contiguous segments do not know the other segment in the itinerary. As such, when one of the segments is delayed, the carrier of the other non-contiguous segments would not know, and will not arrange a new segment for the user.

To solve this problem, in some embodiments, after the itinerary is booked, electronic travel service 140 continues to monitor the status of each segment of the itinerary. Responsive to detecting a delay or cancelation of one of the multiple segments, electronic travel service 140 performs a new search and determines a new set of candidate itineraries for the user to mitigate the problem caused by the cancellation or delay of the one segment. In some embodiments, electronic travel service 140 sends a notification to the client device via the application, showing the user the new set of candidate itineraries. In some embodiments, electronic travel service 140 automatically cancels a following segment that will be affected by the cancellation or delay of the segment, and rebooks a new segment that replaces the canceled segment or follows the delayed segment.

In some embodiments, electronic travel service 140 also includes an AI module 226 for learning users' historical information and generating personalized rankings based on users' historical information. For example, when a user selects one of the candidate itineraries that is not the highest ranked candidate itinerary, the AI module 226 analyzes the user selection and modifies an attribute associated with the user and/or routes having the same origin location and destination location. For example, the attribute may include at least one of (1) a weight of at least one parameter of the plurality of parameters, (2) parameters in the subset of the plurality of parameters, and/or (3) the constrained function to be applied based on the user selection of the candidate itinerary.

Responsive to receiving a new request to booking travel between a new origin location and a new destination location again from the same user, the route generation module 216 and the itinerary determination module 220 determine a new subset of parameters based on the modified attribute associated with the user and/or the route, and applies the same or modified constrained function to the new subset of parameters to determine and rank a new subset of routes. In some cases, the constrained function is modified to cause a different subset of routes to be determined even if the user requests to book a same travel. In some cases, the constrained function is modified to cause a same set of routes to be determined, though with different rankings when the user requests to book the same travel. The new subset of routes or same subset of routes with new rankings can then be used to perform a live search to identify one or more candidate itineraries based on the modified attribute associated with the user and/or routes. The one or more new candidate itineraries may also be ranked based on the modified attribute associated with the user and/or routes. Finally, in response to the updated rankings, the UI generation module 224 generates a new UI that displays the candidate itineraries based on their rankings.

For example, the subset of parameters may include a travel time and a total cost. Applying the subset of parameters to a constrained function may cause the route generation model 216 to identify a subset of routes that has a travel time of fewer than 8 hours, and a total cost of less than $500. These routes are then ranked based on their respective travel time and total cost. For example, by default, electronic travel service 140 may identify three candidate itineraries, and rank them as follows: (1) a first-ranked itinerary having a total travel time of 6 hours and costing $300 (2) a second-ranked itinerary having a total travel time of 5 hours and costing $400 (3) a third-ranked itinerary having a total travel time of 7 hours and costing $300. The subset of routes is then sent to live search module 218 to determine a set of candidate itineraries.

In some cases, the set of candidate itineraries that reflects current data from the carrier may have different parameter values compared to the subset of routes determined based on historical information. In such a case, the set of candidate itineraries may then be ranked based on their parameter values. In some cases, the set of candidate itineraries may have the same or similar parameter values as the subset of routes. In such a case, the set of candidate itineraries may be ranked similarly as the subset of the routes determined based on historical information.

Assuming the set of candidate itineraries is the same as the subset of routes determined and ranked by the route generation module 216. After the UI is generated to display the set of candidate itineraries, the user may select the second-ranked itinerary, which has the lowest total travel time. Responsive to the user's selection of the second-ranked itinerary, the AI module 226 may learn that a total travel time should have been given a greater weight. The user's preference and/or the updated weight may be stored with the user's profile. When the user requests to book travel again, electronic travel service 140 determines candidate itineraries based on the updated weight and/or user preference, resulting in UI generation module 224 to generate different displays for different users customized to each individual user's personal preference.

In particular, the combination of the UI generation module 224 and the AI module 226 dynamically selects and ranks candidate itineraries and displays the ranked candidate itineraries based upon individual user's interaction with a previously generated UI, which is necessarily rooted in computer technology to overcome a problem specifically arising in graphical user interfaces. In particular, automatically identifying user's preferences, prioritizing parameters, and generating display based on individual user's feedback provides specific improvement over prior systems, resulting in an improved user interface for electronic device. (e.g., client device 110).

### Graph Generation Module

FIG. 3 illustrates one embodiment of exemplary modules of the graph generation module. Graph generation module 214 includes record receiving module 302, addition determination module 304, itinerary decompose module 306, parameter encoding module 308, and indexing module 310. The record receiving module 302 is configured to receive and/or identify records that have not been considered to be included in the route graph. In some embodiments, record receiving module 302 may be configured to bulk receive a plurality of historical records associated with one or more client devices of one or more users. Each historical record may be a trip searched and/or booked by a user via the application (e.g., application 111) installed on a client device (e.g., client device 110). Alternatively, or in addition, record receiving module 302 may be configured to receive a new record that is newly generated by a client device via the application. For example, when a user books a new trip via the application, a new booking record is received by record receiving module 302.

Addition determination module 304 determines whether each record received by record receiving module 302 is to be added to the route graph. For example, when a new record corresponds to an existing edge in the graph linking two nodes, addition determination module 304 may determine that data associated with the new record will not be added to the graph because the route graph already includes data associated with the new record.

Responsive to determining, by addition determination module 304, that a record is to be added to the route graph, itinerary decompose module 306 decomposes an itinerary in the record when the itinerary includes multiple segments. For example, an itinerary from airport A to airport D may include three segments, namely, a segment from city A to airport B, a segment from airport B to airport C, and a segment from airport C to airport D. The itinerary decompose module 306 decomposes the itinerary into the three segments. Parameter encoding module 308 then encodes values of one or more parameters associated with the segments. In some embodiments, the parameters may include (but are not limited to) departure time, arrival time, a likelihood of delay, distance traveled, time traveled, a capacity of transportation mean, and/or a cost of a segment. The parameters may also include restrictions associated with the segments, such as (but not limited to) no carry-on luggage, booking in advance, nonrefundable, minimum stay, etc. Finally, indexing module 310 indexes one or more segments in the itinerary into the route graph. In particular, the origin location and the destination location are indexed as nodes of the route graph, and values of the one or more parameters are indexed as edges of the route graph.

FIG. 4 illustrates an exemplary route graph. Route graph 400 includes a plurality of nodes 402-412, and a plurality of edges 422-426. Each of the plurality of nodes 402-412 represents a travel hub location. For example, node 402 represents SFO (San Francisco Airport), node 404 represents BOS (Boston airport), node 412 represents HNL (Honolulu airport), and so on and so forth. Each of the plurality of edges 422-426 links two nodes and includes information indicative of values of parameters obtained based on historical records. The parameters may include (but are not limited to) departure time, arrival time, a likelihood of delay, distance traveled, time traveled, a capacity of transportation mean, a number of carry-on allowed, an airline name, and/or a cost of a segment. For example, edge 422 includes information about flights between BOS 404 to SFO 402, e.g., 5 hours 59 minutes; no carry-on; United Airline; edge 424 includes information about flights between SFO 402 and HNL 412, e.g., 5 hours 14 minutes; 1 carry-on; Hawaiian Airline; and edge 426 includes information about flights between BOS 404 and HNL 412, e.g., 9 hours 40 minutes; 1 carry-on; Hawaiian Airline. In some embodiments, each parameter is assigned a weight, and an overall value is computed for each edge based on the weighted values of the parameters. When there are more flights between two same nodes, additional edges may be added to represent different flights. The edges also include directions. For example, edge 422 is from BOS 404 to SFO 402. For flights going from SFO 402 to BOS 404, another edge pointing in an opposite direction should be added.

### Route Generation Module

FIG. 5 illustrates one embodiment of an exemplary route generation module 216. Route generation module 216 includes entry nodes finding module 502, segment grouping module 504, segment selection module 506, a subgraph generation module 508, and routes selection module 510. Entry nodes finding module 502 finds entry nodes associated with an origin location and/or a destination location. Segment grouping module 504 groups segments by a subset of a plurality of parameters. In some embodiments, the subset of parameters may include (but are not limited to) time ranges and/or dates of week, duration, number of stops, and price. The segment grouping module 504 ensures routes are valid in terms of sequence of hubs (e.g., airports) they travel. Segment selection module 506 then compares values of the subset of parameters (or a weighted average of the subset of parameters) of the segments in a same time range and/or date of week, and selects a segment from each time range and/or date of week that has highest ranking of value(s) (or highest ranking of weighted average) of the one or more parameters. The default method of ranking values may be set by route generation module 216. For example, generally, a shorter total travel time is ranked higher; a shorter layover time is also ranked higher; allowing carry-on is ranked higher, etc. Subgraph generation module 508 then generates a subgraph based on the selected segments. Routes selection module 510 then selects a subset of routes in the subgraph that have an origin location and a destination location corresponding to the entry nodes.

FIG. 6 illustrates one embodiment of an exemplary process 600 that may be performed by segment selection module 506. Each day is divided into a plurality of time ranges, namely morning 612, afternoon 614, and evening 616. Each of the time ranges 612, 614, 616 may have equal lengths or unequal lengths, which may depend on a total number of trip segments available during different periods of a day. Segment selection module 506 groups travel segments 622-644 between any given origin location and destination location into a plurality of groups based on their departure times. Note, each travel segment corresponds to a non-stop trip, including an origin location and a destination location, and no layovers therebetween. As illustrated, the departure times of segments 622, 624, 626 all fall in morning range 612; thus, these travel segments 622, 624, and 626 are grouped together as a single group 620. Similarly, the departure times of segments 632, 634, and 636 all fall in afternoon range 614; thus, these segments are grouped together as a single group 630. Again, departure times of segments 642 and 644 both fall in evening range 616; thus, these segments 642, 644 are grouped together as a single group 640.

For each group, segment selection module 506 selects subsets of the segments based on their values of one or more parameters. In some embodiments, a single segment that has the highest ranking values of the subset of parameters (or the highest ranking weighted average of the subset of parameters) is selected for each group. For example, the subset of parameters may include a cost and allowance of carry-on. In such a case, a segment that has the lowest cost and also allows carry-on is selected in each time range 612, 614, 616. As another example, the subset of parameters may include a cost and a cancellation rate. The constrained function may be that the cancellation rate needs to be lower than 1%. In such a case, a segment that has the lowest cost and also has a cancellation rate lower than 1% is selected in each time range 612, 614, 646 In some embodiments, the subset of parameters may be selected by the electronic travel service 140 as default subset of parameters. In some embodiments, the subset of parameters may be set based on a user's indication and/or preference received from the application (e.g., application 111) installed on a client device (e.g., client device 110). In some embodiments, the one or more parameters may be set based on the user's historical data by an AI module (e.g., AI module 226).

As illustrated, segment C 626 (having the highest ranking values of parameters in group 620) is selected for the group that shares their departure time in morning range 612, segment D 632 (having the highest ranking values of parameters in group 630) is selected for the group that shares their departure time in afternoon range 614, and segment G 642 (having the highest ranking values of parameters in group 640) is selected for the group that shares their departure time in evening range 616. The selected segments are then used by subgraph generation module 510 to generate a subgraph. The subgraph is then used by the routes selection module to generate a subset of routes, which in turn be used by itinerary determination module 220 to determine one or more candidate itineraries. At least one of the one or more candidate itineraries includes at least one component from each of at least two non-contiguous segments.

### Exemplary User Interface

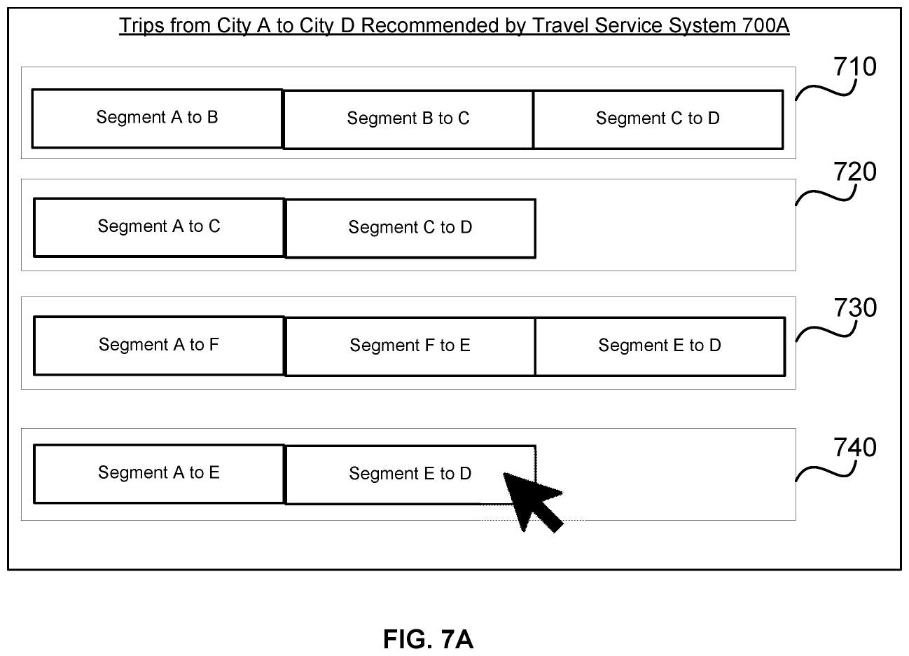

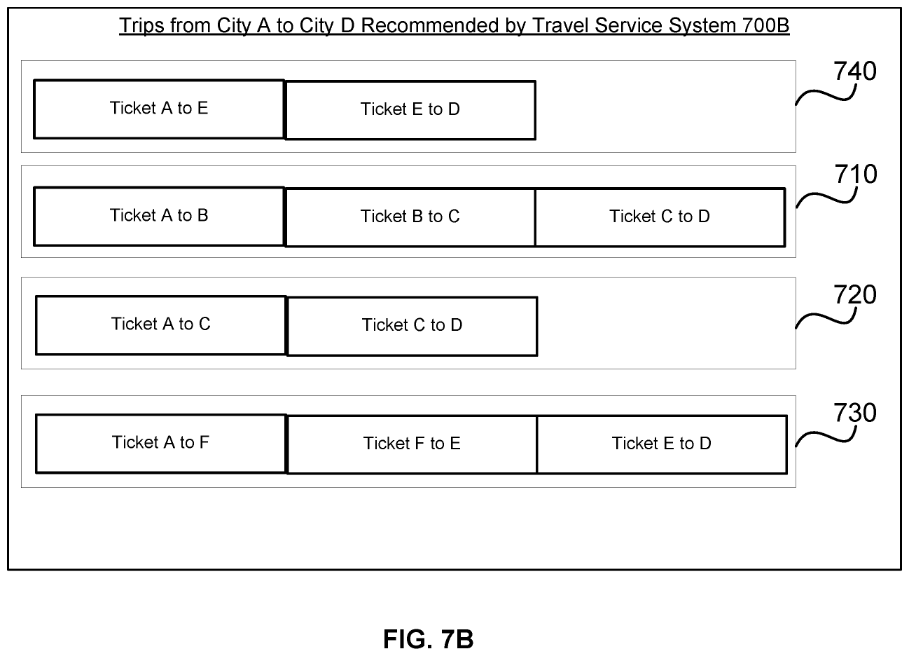

FIGS. 7A and 7B illustrate an embodiment of exemplary UI 700A, 700B generated by UI generation model 224 for displaying one or more candidate itineraries from airport A to city D determined by itinerary determination module 220. As illustrated in FIG. 7A, UI 700A displays four candidate itineraries 710, 720, 730, 740. The four candidate itineraries 710-740 are ranked based on a subset of parameters and/or a constrained function, and displayed based on their respective rankings. The highest ranked candidate itinerary 710 is displayed a highest and/or a most prominent location in the UI 700A. Itinerary 720 is the second highest ranked itinerary, and so on and so forth.

The first candidate itinerary 710 includes three segments, namely a segment from airport A to city B, a segment from city B to city C, and a segment from city C to city D. The second candidate itinerary 720 includes two segments, namely a segment from city A to city C, a segment from city C to city D. Similarly, the third candidate itinerary 730 includes three segments, namely a segment from city A to city F, a segment from segment F to segment E, and a segment E to segment D. Again, the fourth candidate itinerary includes two segments, namely segment from city A to city E, and a segment from city E to city D.

A user can select one of the candidate itineraries to review further details of the selected candidate itinerary and/or book the candidate itinerary. The user's interaction with the itineraries may be recorded as a part of the history data 232, which can further be used by AI module 226 to modify an attribute associated with the user and/or a route having the same origin location and destination location. For example, the attribute may include at least one of (1) a weight of at least one parameter of the subset of the plurality of parameters, (2) parameters in the subset of the plurality of parameters based on the user selection, or (3) the constrained function. For example, when the user does not select the top-ranked itinerary 710, but the fourth itinerary 740, the user's selection is recorded in the historical data 232, which can then be used as feedback to modify at least one of (1) a weight of at least one parameter of the subset of the plurality of parameters, (2) parameters in the subset of the plurality of parameters based on the user selection, and/or (3) the constrained function. The modification causes the user-selected itinerary to be ranked higher responsive to receiving a new request. Such a feedback loop can be implemented not only to customize ranking for a particular user, but also to customize route selection and trip building process for all users.

For example, after the user selects the fourth itinerary 740, at least one of (1) a weight of at least one parameter of the subset of the plurality of parameters, (2) parameters in the subset of the plurality of parameters based on the user selection, and/or (3) the constrained function are modified based on the user's selection, such that when the user requests to book a travel with the same origin location (e.g., city A) and destination location (e.g., city D), route generation module 216 and itinerary determination module 220 generate a different set of candidate itineraries and/or ranking the same set of candidate itineraries 710-740 differently. FIG. 7B illustrates another example UI 700B that is updated responsive to user's previous selection of itinerary 740 via UI 700A. As illustrated in FIG. 7B, itinerary 740 is now listed at the highest ranking itinerary, and the rest of the itineraries 710-730 are listed below itinerary 740. Such changes are caused by the user's previous selection of itinerary 740.

Notably, different users may have their own personal priorities, and desire itineraries with different parameters. The embodiments described above allow the electronic travel service system 140 to customize the parameter and constraint functions based on individual user's preference, improving the function of the system 140 in the technical field of online travel booking.

### Computing Machine Architecture

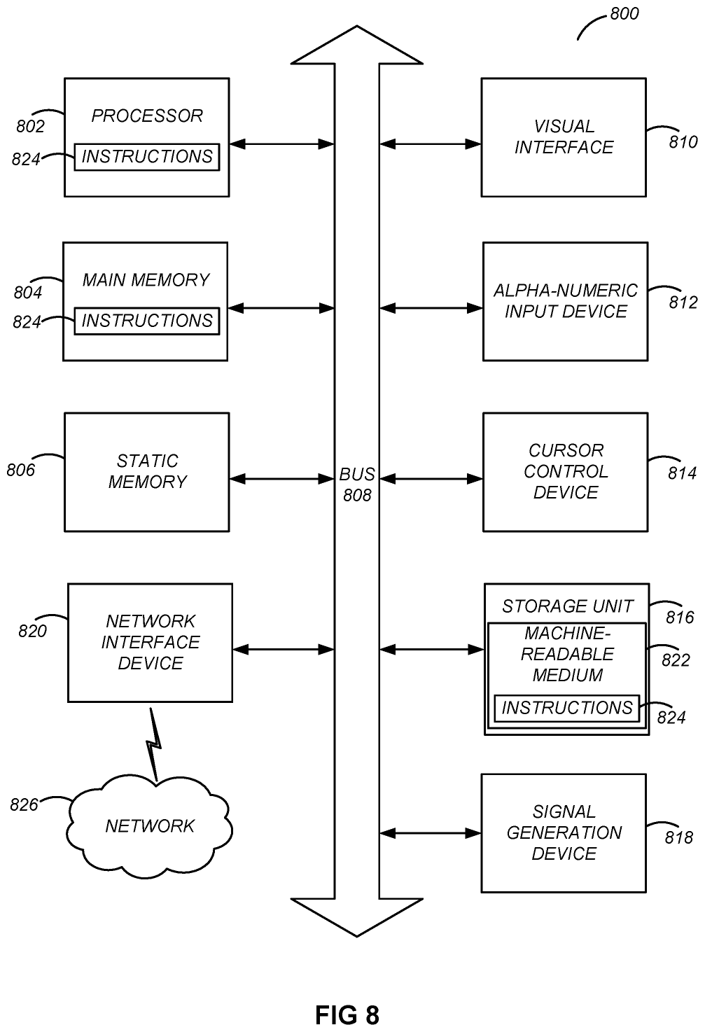

FIG. 8 is a block diagram illustrating components of an example machine able to read instructions from a machine-readable medium and execute them in a processor (or controller). Specifically, FIG. 8 shows a diagrammatic representation of a machine in the example form of a computer system 800 within which program code (e.g., software) for causing the machine to perform any one or more of the methodologies discussed herein may be executed. The program code may be comprised of instructions 824 executable by one or more processors 802. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions to perform any one or more of the methodologies discussed herein.

The example computer system 800 includes a processor 802 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 804, and a static memory 806, which are configured to communicate with each other via a bus 808. The computer system 800 may further include visual display interface 810. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 810 may include or may interface with a touch enabled screen. The computer system 800 may also include alphanumeric input device 812 (e.g., a keyboard or touch screen keyboard), a cursor control device 814 (e.g., a mouse, a trackball, a joystick, a motion sensor, or other pointing instrument), a storage unit 816, a signal generation device 818 (e.g., a speaker), and a network interface device 820, which also are configured to communicate via the bus 808.

The storage unit 816 includes a machine-readable medium 822 on which is stored instructions 824 (e.g., software) embodying any one or more of the methodologies or functions described herein. The instructions 824 (e.g., software) may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 (e.g., software) may be transmitted or received over a network 826 via the network interface device 820.

While machine-readable medium 822 is shown in an example embodiment to be a single medium, the term “machine-readable medium” should be taken to include a single medium or multiple media (e.g., a centralized or distributed database, or associated caches and servers) able to store instructions (e.g., instructions 824). The term “machine-readable medium” shall also be taken to include any medium that is capable of storing instructions (e.g., instructions 824) for execution by the machine and that cause the machine to perform any one or more of the methodologies disclosed herein. The term “machine-readable medium” includes, but not be limited to, data repositories in the form of solid-state memories, optical media, and magnetic media.

### Exemplary Data Flow for Generating and Displaying Candidate Itineraries for Travel.

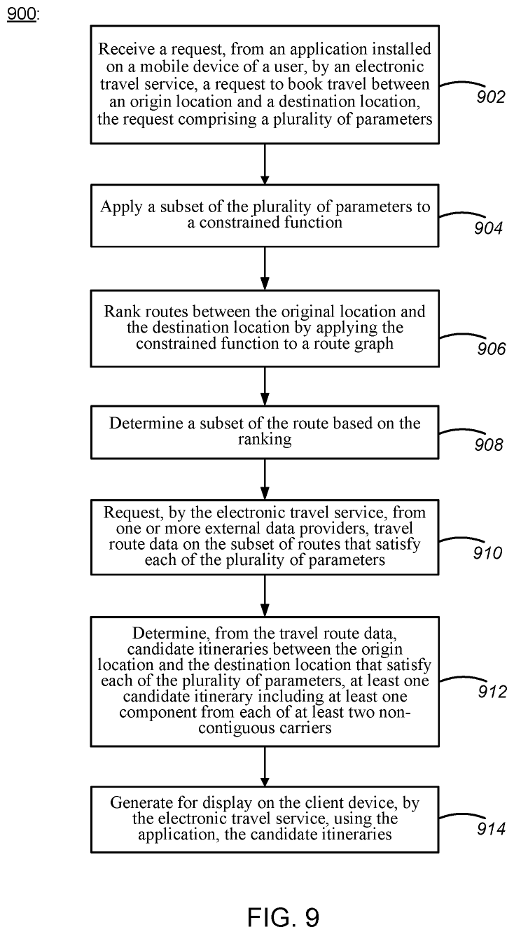

FIG. 9 illustrates one embodiment of an exemplary flow chart for generating and displaying candidate itineraries for travel at an application installed on a client device. Process 900 begins with a processor (e.g., of electronic travel service 140) receiving 902, from an application (e.g., application 111) installed on a client device (e.g., client device 110) a request to book travel between an origin location and a destination location (e.g., using query receiving module 212). The request comprises a plurality of parameters. Responsive to receiving the request, the processor applies 904 a subset of the plurality of parameters to a constrained function (e.g., constrained function 234), and ranking 906 routes between the origin location and the destination location by applying the constrained function to a route graph (e.g., route graph 400). The route graph (e.g., route graph 400 generated by graph generation module 214) includes a plurality of nodes (e.g., nodes 402-412) and a plurality of edges (e.g., 422-448). The edges connect nodes, and the edges include information indicative of historical parameters of historical information (e.g., historical data 232) indicating that one or more carriers service travel between connected nodes. In some embodiments, the historical information is obtained from prior usage of the application installed on various client devices and stored on one or more databases of the electronic travel service.

The processor then ranks 906 the identified routes based on their values of the subset of the plurality of parameters, and determines 908 a subset of the routes based on the ranking, and requests 910 from one or more external data providers (e.g., external data provider 130) travel route data on the subset of routes that satisfy each of the plurality of parameters (e.g., using route generation module 216). After that, the processor determines 912 one or more candidate itineraries between the origin location and the destination location that satisfy each of the plurality of parameters (e.g., using live search module 218). In particular, at least one candidate itinerary includes at least one component from each of at least two non-contiguous segments. Finally, the processor generates 914 for display on the client device, using the application, the candidate itineraries (e.g., using UI generation module 224).

### ADDITIONAL CONFIGURATION CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations. In other example embodiments, fewer or more modules may be used by the electronic travel service 140 to achieve the same or similar functionalities disclosed herein.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for performing database operations on historical travel data and analysis for virtual interlining of travel routes through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
receiving, from an application installed on a client device, by an electronic travel service, a request to book travel between an origin location and a destination location, the request associated with a plurality of parameters;
responsive to receiving the request:
applying a subset of the plurality of parameters to a constrained function,
ranking routes between the origin location and the destination location by applying the constrained function to a route graph, the route graph comprising nodes representing travel hub locations and edges connecting nodes where historical information indicates that one or more carriers service travel between connected nodes, the edges comprising information indicative of historical parameters of the historical information, the historical information obtained from prior usage of the application installed on various client devices and stored on one or more databases of the electronic travel service, and
determining a subset of the routes based on the ranking;
requesting, by the electronic travel service, from one or more external data providers, travel route data on the subset of routes that satisfies each of the plurality of parameters;
determining, from the travel route data, candidate itineraries between the origin location and the destination location that satisfy each of the plurality of parameters, at least one of the candidate itineraries including at least one component from each of at least two non-contiguous segments; and
generating for display on the client device, by the electronic travel service, using the application, the candidate itineraries.

2. The method of claim 1, wherein the plurality of parameters comprise one or more of: indicia of directionality of route, maximum number of layovers, acceptable carriers, duration constraints, and layover time constraints.

3. The method of claim 2, wherein each parameter of the subset of the plurality of parameters is weighted according to the constrained function.

4. The method of claim 3, wherein determining the subset of routes comprises selecting, from the candidate routes, a predefined amount routes having a highest ranking.

5. The method of claim 3, wherein the method further comprises:
generating a route subgraph based on the travel route data received from the external data providers;
ranking routes between the origin location and the destination location by applying the constrained function to the route subgraph;
determining the candidate itineraries based on the ranking of the routes in the route subgraph; and
generating for display on the client device the candidate itineraries and rankings thereof.

6. The method of claim 5, wherein the method further comprises:
receiving a user selection of one of the candidate itineraries from the application installed on a client device, by the electronic travel service, the selected candidate itinerary not being a highest ranked candidate itinerary; and
modifying, based on the user selection of candidate itinerary, an attribute, the attribute being at least one of a weight of at least one parameter of the subset of the plurality of parameters, the subset of the plurality of parameters based on the user selection, or the constrained function.

7. The method of claim 6, wherein the method further comprises:
responsive to receiving a new request to book travel between the origin location and the destination location, determining new candidate itineraries between the origin location and the destination location, and ranking the new candidate itineraries based on the modified attribute, causing the previously user selected candidate itinerary to be ranked at a higher rank; and
generating for display on the client device, by the electronic travel service, using the application, the candidate itineraries based on the rankings where the user previously selected candidate itinerary is displayed at a higher or more prominent position.

8. The method of claim 1, wherein the subset of the plurality of parameters or weights of the subset of the plurality of parameters are user based, such that each user corresponds to a separate subset of the plurality of parameters or weights of the subset of the plurality of parameters based on historical information associate with the user.

9. The method of claim 1, wherein applying the subset of the plurality of parameters to the constrained function comprises:
dividing departure times of direct routes in the route graph having a same origin and a same destination into a plurality of time ranges, a direct routes are routes having two nodes directly connected to each other by a single edge;
for each of the plurality of time ranges:
ranking a subset of direct routes in the route graph having the same origin and the same destination that have departure times in the time range based on values of the subset of parameters of the subset of routes, and
selecting a route from the subset of direct routes in the route graph having the same origin and the same destination as a candidate direct route based the ranking of the subset of direct routes.

10. A computer system comprising:
a processor; and
a computer-readable storage medium having instructions encoded thereon that, when executed by the processor, cause the processor to:
receive, from an application installed on a client device, by an electronic travel service, a request to book travel between an origin location and a destination location, the request associated with a plurality of parameters;
responsive to receiving the request:
apply a subset of the plurality of parameters to a constrained function,
rank routes between the origin location and the destination location by applying the constrained function to a route graph, the route graph comprising nodes representing travel hub locations and edges connecting nodes where historical information indicates that one or more carriers service travel between connected nodes, the edges comprising information indicative of historical parameters of the historical information, the historical information obtained from prior usage of the application installed on various client devices and stored on one or more databases of the electronic travel service, and
determine a subset of the routes based on the ranking;
request, by the electronic travel service, from one or more external data providers, travel route data on the subset of routes that satisfies each of the plurality of parameters;
determine, from the travel route data, candidate itineraries between the origin location and the destination location that satisfy each of the plurality of parameters, at least one of the candidate itineraries including at least one component from each of at least two non-contiguous segments; and
generate for display on the client device, by the electronic travel service, using the application, the candidate itineraries.

11. The computer system of claim 10, wherein the plurality of parameters comprise one or more of: indicia of directionality of route, maximum number of layovers, acceptable carriers, duration constraints, and layover time constraints.

12. The computer system of claim 11, wherein each parameter of the subset of the plurality of parameters is weighted according to the constrained function.

13. The computer system of claim 12, wherein determining the subset of routes comprises selecting, from the candidate routes, a predefined amount routes having a highest ranking.

14. The computer system of claim 12, wherein the computer system is further caused to:
generate a route subgraph based on the travel route data received from the external data providers;
rank routes between the origin location and the destination location by applying the constrained function to the route subgraph;
determine the candidate itineraries based on the ranking of the routes in the route subgraph; and
generate for display on the client device the candidate itineraries and rankings thereof.

15. The computer system of claim 14, wherein the computer system is further caused to:
receive a user selection of one of the candidate itineraries from the application installed on a client device, by the electronic travel service, the selected candidate itinerary not being a highest ranked candidate itinerary; and
modifying, based on the user selection of candidate itinerary, an attribute, the attribute being at least one of a weight of at least one parameter of the subset of the plurality of parameters, the subset of the plurality of parameters based on the user selection, or the constrained function.

16. The computer system of claim 15, wherein the computer system is further caused to:
responsive to receiving a new request to book travel between the origin location and the destination location, determine new candidate itineraries between the origin location and the destination location, and ranking the new candidate itineraries based on the modified attribute, causing the previously user selected candidate itinerary to be ranked at a higher rank; and
generate for display on the client device, by the electronic travel service, using the application, the candidate itineraries based on the rankings where the user previously selected candidate itinerary is displayed at a higher or more prominent position.

17. The computer system of claim 10, wherein the subset of the plurality of parameters or weights of the subset of the plurality of parameters are user based, such that each user corresponds to a separate subset of the plurality of parameters or weights of the subset of the plurality of parameters based on historical information associate with the user.

18. The computer system of claim 10, wherein applying the subset of the plurality of parameters to the constrained function comprises:
dividing departure times of direct routes in the route graph having a same origin and a same destination into a plurality of time ranges, a direct routes are routes having two nodes directly connected to each other by a single edge;
for each of the plurality of time ranges:
ranking a subset of direct routes in the route graph having the same origin and the same destination that have departure times in the time range based on values of the subset of parameters of the subset of routes, and
selecting a route from the subset of direct routes in the route graph having the same origin and the same destination as a candidate direct route based the ranking of the subset of direct routes.

19. A computer program product comprising a computer-readable medium having instructions encoded thereon that, when executed by a processor, cause the processor to:
receive, from an application installed on a client device, by an electronic travel service, a request to book travel between an origin location and a destination location, the request associated with a plurality of parameters;
responsive to receiving the request:
apply a subset of the plurality of parameters to a constrained function,
rank routes between the origin location and the destination location by applying the constrained function to a route graph, the route graph comprising nodes representing travel hub locations and edges connecting nodes where historical information indicates that one or more carriers service travel between connected nodes, the edges comprising information indicative of historical parameters of the historical information, the historical information obtained from prior usage of the application installed on various client devices and stored on one or more databases of the electronic travel service, and
determine a subset of the routes based on the ranking;
request, by the electronic travel service, from one or more external data providers, travel route data on the subset of routes that satisfies each of the plurality of parameters;
determine, from the travel route data, candidate itineraries between the origin location and the destination location that satisfy each of the plurality of parameters, at least one of the candidate itineraries including at least one component from each of at least two non-contiguous segments; and
generate for display on the client device, by the electronic travel service, using the application, the candidate itineraries.

20. The computer program product of claim 19, wherein the plurality of parameters comprise one or more of: indicia of directionality of route, maximum number of layovers, acceptable carriers, duration constraints, and layover time constraints.
